(19) United States
(12) Patent Application Publication
(10) Pub. No.: US 2013/0085799 A1
(43) Pub. Date: Apr. 4, 2013

(54) METHOD AND APPARATUS FOR IMPROVING BUSINESS PROCESS MANAGEMENT SYSTEMS

(71) Applicants: Shuan Zhang, Milpitas, CA (US); Jesse Shiah, Cupertino, CA (US)

(72) Inventors: Shuan Zhang, Milpitas, CA (US); Jesse Shiah, Cupertino, CA (US)

(73) Assignee: AGILEPOINT, INC., MOUNTAIN VIEW, CA (US)

(21) Appl. No.: 13/639,426

(22) PCT Filed: Apr. 8, 2011
(86) PCT No.: PCT/US11/00638

§ 371 Date: Dec. 4, 2012

Related U.S. Application Data
(60) Provisional application No. 61/321,991, filed on Apr. 8, 2010.

(51) Int. Cl. G06Q 10/06

(52) U.S. Cl. CPC G06Q 10/06316
USPC 705/7.26

(57) ABSTRACT

A business process management system comprises a core process model and a highly configurable extension component. The extension component includes extension process elements and functionality that are configured to operate in connection with a subset of core process elements so as to execute a particular business process management function on the subset. The extension process elements and functionality are entirely separate from and are not a part of the process flow containing the subset of core process elements such that the business process management function does not affect or influence the core process flow. Examples of business process management functions configurable for such purposes include service level agreements, business process monitoring and KPI collection, policy compliance and trend prediction.

### FIELD OF THE INVENTION

The disclosure relates generally to business management process systems, and more particularly, to providing computerized methods and apparatuses directed to configurable extensions that exist and operate outside the core business processes. These extensions are highly flexible in that they operate on the metadata provided by the business management process system and may be used to implement any of a number of business processes.

### BACKGROUND OF THE INVENTION

The statements in this section merely provide background information related to the present disclosure and may not constitute prior art.

Business Process Management (BPM) is a large and growing area of IT-based business management that is essential for the successful operation of a sophisticated business. Today's global marketplace demands the efficiencies that BPM enables. Further, the sheer size and complexity of present daily business tasks often require the use of technology to model and fully understand those tasks. BPM is a holistic management approach that bridges organizational and technological paradigms and focuses on aligning all aspects of a business organization so as to better serve the wants and needs of the business' customers. While the primary goals of BPM are the promotion of business process effectiveness and efficiency, an equally important aspect of BPM implementation is the process of continuous process improvement itself. When automated through the use of computer-based tools, business processes can be strictly and precisely monitored and managed in a relatively inexpensive manner and with minimal human resources being dedicated to process management tasks. This enables businesses to continue to innovate and grow their core business without being overburdened, financially or by resources, with the monitoring of the internal business processes that enable the very business to function.

BPM systems can be expensive to implement, often on the order of hundreds of thousands of dollars of capital investment. As a result, it is estimated that on average, organizations have only 5% of their operations driven by a BPM suite. To implement BPM functionality, significant and sophisticated information technology (IT) resources are typically required to define and model the various business processes that are to be captured and managed. Once completely defined and modeled, from an initial operational standpoint, BPM systems are tested extensively for accuracy and robustness. The entire initial process of BPM creation is typically expensive, time-consuming and IT intensive, particularly in its requirements for an expert level of support. After the BPM systems are up and running, however, the business' interaction with the BPM system changes from one of defining and implementing operational processes to evaluating and managing those processes. This is where the business value lies.

However, the direct introduction of additional processes or functionality, such as monitoring, management, compliance, etc. into the operational BPM processes flow is undesirable for several reasons. First, as the number of BPM management and monitoring process steps increase, the overall BPM process flow begins to balloon, exponentially, with each added management and monitoring process. This renders the original BPM system unwieldy, inefficient, unrecognizable and incapable of change. Second, in contrast to the expert IT support needed for initial BPM definition, modeling and testing, the management, monitoring and metadata collection processes, implemented on an existing BPM system are often defined and created by business persons or business analysts. Thus, higher-priced IT resources must be retained when higher order management or capability expanding functionality is included into the operational business processes. Furthermore, the IT personnel must acquire some level of business familiarity to properly design and model those higher order processes. This is an expensive and inefficient use of IT resources on an ongoing basis.

U.S. Pat. No. 7,904,302, Issued Mar. 8, 2011 to Adendorff et al, provides background for a complete system and method for BPM, the entire contents of which is incorporated herein in its entirety. Despite its lengthy treatment of BPM systems, however, Adendorff et al does not provide for a highly configurable and agile mechanism by which the operational business processes within a BPM system can be changed on the fly with minimal core process disruption and redefinition and without the need for expensive IT reprogramming resources. Thus the need exists in the BPM system design space to accommodate a flexible, higher-ordered BPM programming platform for defining and implementing non-core BPM processes.

### SUMMARY OF THE INVENTION

According to one aspect of the invention a computer based process management system is provided, the process management system having a process engine that manages a process flow within a process model, the process flow containing a plurality of process elements, the process management system including: an extension component disposed outside of and coupled to the process model for interacting with a subset of the process elements within the process flow, the extension component managed by the process engine and configured to perform a particular extension function. The invention may optionally include implementing a service level agreement, the service level agreement ensuring that the subset of process elements is traversed within a specified time period; performance monitoring of the subset of process elements by collecting key performance indicators; verification of policy compliance of the subset of process elements; evaluation of business conditions within the subset of process elements and taking actions based on the evaluation; business conditions that are evaluated directly by the extension component and the actions include dynamic process modification of the subset of process elements; business conditions that are evaluated with the extension component using a rules engine that is part of the process model and the actions include dynamic process modification of the subset of process elements. Also optionally included, are the particular extension function where it includes predication of process trends within the subset of process elements based on statistical historical data regarding the process model; the particular extension function where it includes alert monitoring within the subset of process elements; a particular extension function that includes evaluation of business conditions within the subset of process elements and taking actions based on the evaluation; a plurality of the extension components to perform a plurality of particular extension functions; or a business process management system wherein the process model is a business process model, the process engine is a business process engine, the process flow is a business process flow within the business process model, the plurality of process elements are a plurality of business process elements and the particular extension function performed by the extension component is a particular business extension function.

In another aspect of the invention a computer-based extension component is provided for use with a process management system, the process management system modeling a process and having a process engine that manages a process flow within the process model, the process flow containing a plurality of process elements, the extension component including: an extension foundation for coupling to and communicating with the process management system; an extension framework having a design-time component and a run-time component, the design time component including an environment system including a user interface, the run-time component including an process engine for executing the extension component processes, the extension processes operating in connection with the process engine but decoupled from the process elements a subset of the process elements and configured by a user to perform a particular extension function.

In yet another aspect of the invention, a method for operating a computer-based process management system is provided, the process management system having a process engine that manages a process flow within a process model, the process flow containing a plurality of process elements, a subset of the process elements including a starting event and an ending event, the method including: capturing the starting event associated with a subset of the process element within the process flow; activating an extension component containing extension model process elements upon capturing the starting event, the extension component process elements being separate from and operating in parallel with the subset of process elements within the process flow; executing the extension component process elements until either the ending event is reached within the process flow or it is determined by the extension component that the ending event is not able to be reached; and terminating execution of the extension component process elements. Further included is the method wherein the step of activating includes activating the extension model process elements for executing a service level agreement, the extension model process elements including the service level agreement, the step of executing further including the steps: activating a sub-process timer associated with the subset of process elements; monitoring the sub-process timer to determine a sub-process execution time for the subset of process elements; and triggering an alert if the sub-process time exceeds a maximum sub-process execution time. Also considered is the method wherein the step of capturing includes detection of a change in process data and the step of activating includes activating the extension model process elements for executing a performance monitoring function, the extension model process elements including the performance monitoring function, the step of executing further including the steps of: collecting key performance indicators associated with the subset of process elements; and reporting the key performance indicators to the extension component for evaluating a performance of the subset of process elements; or wherein the step of activating includes activating the extension model process elements for executing a policy compliance function, the extension model process elements including the policy compliance function, the step of executing further including the steps: evaluating the subset of process elements for compliance with a standard; evaluating the subset of process elements for compliance with the standard; and triggering an alert if the subset of process elements is not compliant with the standard. Also optionally included is the method wherein the step of activating includes activating the extension model process elements for executing an alerting function, the extension model process elements including the alerting function, the step of executing further including the steps: monitoring the subset of process elements for conditions outside of a normal process range; triggering an alert if the subset of process elements is outside of the normal process range; or alternatively the method wherein the step of activating includes activating the extension model process elements for executing a trend predication function, the extension model process elements including the trend predication function, the step of executing further including the steps: evaluating a historical operation associated with the subset of process elements; and adjusting at least one of the subset of process elements as the result of the evaluation.

Finally, other aspects of the invention include computer readable media having executable instructions for causing a processor to perform the methods described above

### BRIEF DESCRIPTION OF THE DRAWINGS

The accompanying drawings, which are incorporated in and constitute part of this specification, illustrate embodiments of the invention and together with the description, serve to explain the principles of the invention. Like references indicate similar elements among the figures and such elements are illustrated for simplicity and clarity and have not necessarily been drawn to scale. The embodiments illustrated herein are all presently preferred, it being understood, however, that the invention is not limited to the precise arrangements and instrumentalities shown, wherein:

FIG. 1 is an exemplary business process management (BPM) architecture diagram;

FIG. 2 is an exemplary BPM extension architecture diagram according to one embodiment of the invention;

FIGS. 3A, 3B, and 3C show exemplary BPM process models in which higher order extension process elements are embedded within the process flow (FIGS. 3A-3B) and in which they are removed from the process flow (FIG. 3C);

FIG. 4 is a flowchart of the operation of an extension process according to the present invention;

FIG. 5 is a process event diagram corresponding to a service level agreement function;

FIG. 6 is a process event diagram corresponding to a real-time business monitoring function and key performance indicators collection function;

FIG. 7 is a process event diagram corresponding to a policy compliance function;

FIG. 8 is a process event diagram corresponding to a trend prediction function; and

FIG. 9 is a graphical representation of the application of a plurality of extension components and processes to a process flow.

### DESCRIPTION OF THE INVENTION EMBODIMENTS

To facilitate a clear understanding of the present invention, illustrative examples are provided herein which describe certain aspects of the invention. However, it is to be appreciated that these illustrations are not meant to limit the scope of the invention, and are provided herein to illustrate certain concepts associated with the invention.

It is also to be understood that the present invention may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture. In one aspect, the machine may be implemented on a computer system having hardware such as one or more central processing units (CPU), a random access memory (RAM), and input/output (I/O) interface(s). The computer system also includes an operating system and microinstruction code. The various processes and functions described herein may either be part of the microinstruction code or part of the program (or combination thereof) which is executed via the operating system that governs the machine. In addition, various other peripheral devices may be connected to the computer system such as additional data storage devices and printing devices. The computer system may also be connected to a network on which programs, data, rules, functions and any other components described herein may be stored and/or made available to the computer system, or through which users may view and/or provide control mechanisms to the computer system.

It is to be understood that, because some of the constituent system components and method steps depicted in the accompanying figures are preferably implemented in software, the actual connections between the system components (or the process steps) may differ depending upon the manner in which the present invention is programmed. As shown in FIGS. 1-9, this invention is preferably implemented using a general purpose computer system. However the systems and methods of this invention can be implemented using any combination of one or more programmed general purpose computers, programmed microprocessors or micro-controllers and peripheral integrated circuit elements, ASIC or other integrated circuits, digital signal processors, hardwired electronic or logic circuits such as discrete element circuits, programmable logic devices such as a PLD, PLA, FPGA or PAL, or the like. In general, any device capable of implementing a finite state machine that is in turn capable of implementing any flowcharts or process flow described herein can be used to implement this system.

It should be noted certain terms are used interchangeably throughout the specification. This is done without any intention to conflate the specific definitions of the terms, but rather to simply differentiate core from non-core business processes. With respect to core business processes, alternative terms include operational processes, in-process, in-flight, and base processes. With respect to non-core business processes, alternative terms include management business processes, higher order (business) processes, and extension processes.

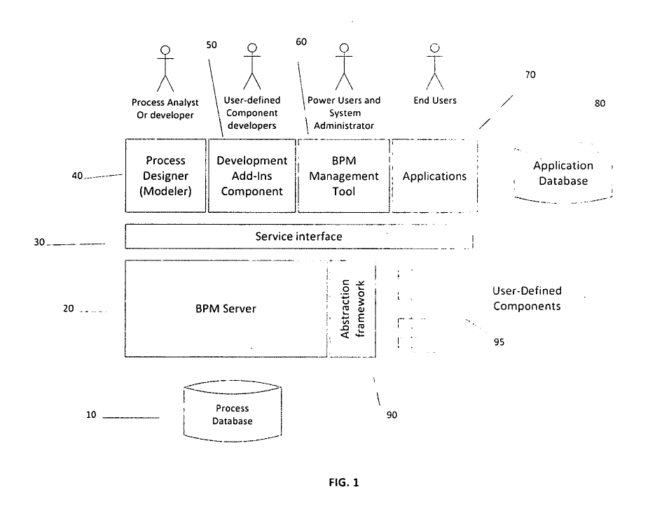

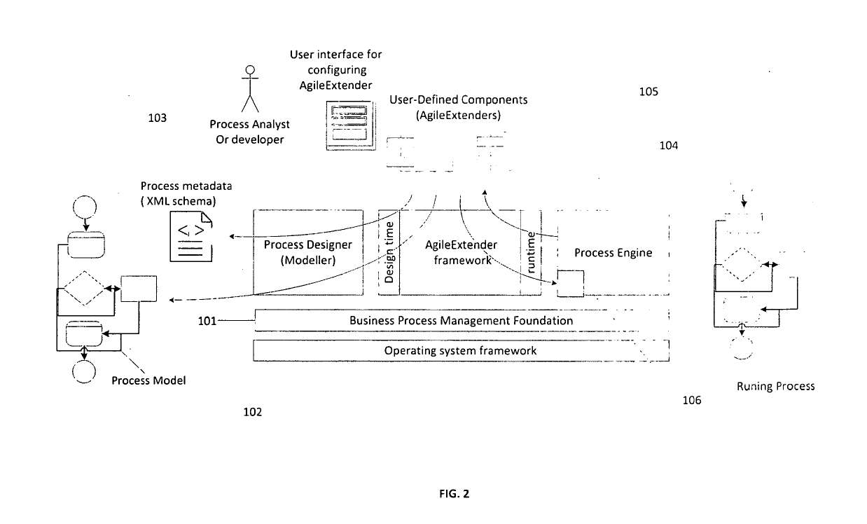

FIG. 1 provides an exemplary server architecture 1 for a BPM according to the present invention. Process database 10 (e.g., Microsoft SQL Server, Oracle) is provided to store data pertaining to persistent process model, process states and process management. BPM server 20 is shown and includes various elements including a process execution engine and performs the following functions: process execution engines, process model management, process state management, loading balance management, role-base authorization management, process swapping management, process exception handler, process archive and restore service, process model deployment services, notification services and process time services. Service-base application development interface (API) 30 is provided for access BPM server functions, for example, to deploy process models, initiate process instances, and/or manage/change runtime process instance. It supports standard web service and windows communication functions. Process designer (modeler) 40 is also provided for allowing process analysts and developers to model processes the same within the BPM system. The development add-ins component 50 is shown and provides project types and basic functions for developing user-defined extended components. Web-based dash-board 60 is shown for managing process models, processes, tasks, users, roles the run time processes and run time models. User-defined application 70 can be provided and if so, is integrated with BPM server through the service-base API 50. The database 80 is used to store persistent user-defined application data. Abstraction framework 90 enables the interaction between user-defined extended component and process designer (model) by accessing process model and process metadata through its own user interface at design time. It also makes extended component configurable, reusable and visible without having to understand all the underlying details within the models and metadata. At runtime, the user-defined extended component receives subscribed process events that are relayed by the framework and change process behavior through server side API. User-defined component 95 is built on top of abstraction framework, FIG. 2, 105, runs within BPM engine runtime context and interacts with engine through server side API event handlers to change default behavior of process model dynamically. The framework supports four types of extension models: human activity (e.g., a process step), system activity (e.g., accessing a database), extension component, system connector (e.g., extending server functionality).

FIG. 2 provides an exemplary extension component architecture 100 for an extension component according to the present invention. Business process management foundation 101 provides basic functionality to access the BPM server 10. Examples of such functionality are process definition, runtime process instance, and tasks. At design time, one or more user-defined extension components can be ‘associated’ with a process model 102 (not inserted as an element of the process model) in the process modeler to enable the process model with the option to trigger or turn-on the extension component functionality at run-time, on demand. The user-defined extension component 103 is able to access process model and process metadata (XML schema) through the abstraction framework enables at design time. It runs as add-ins components to process designer (modeler) and provide user interface for configuration that can be persistent by abstraction framework as part of process model. The engine fires events 104 when it drives running process, e.g., stop/start the process or assign/cancel tasks. The engine also fires events 104 when requests are submitted by external applications, for example, when the process is initiated, when the process is suspended, when the task is being assigned a user, when the process state is being updated, or when a task is being re-assigned to substitute user. The abstraction framework will relay events to the user-defined component if the component subscribes to the event which then provides feedback to the engine. For example, when process state is being updated, if it does not align with company policy, the engine will cancel the transaction of the update. The user-defined component can also change behavior of process dynamically 105 through the server side API base on its design and configuration. For example, when a task is being assigned, a resource optimization component can check the number of assigned task and balance the workload, and send alert for potential resource allocation program. The server side API 106 is for accessing engine functions directly within the context of engine execution and security.

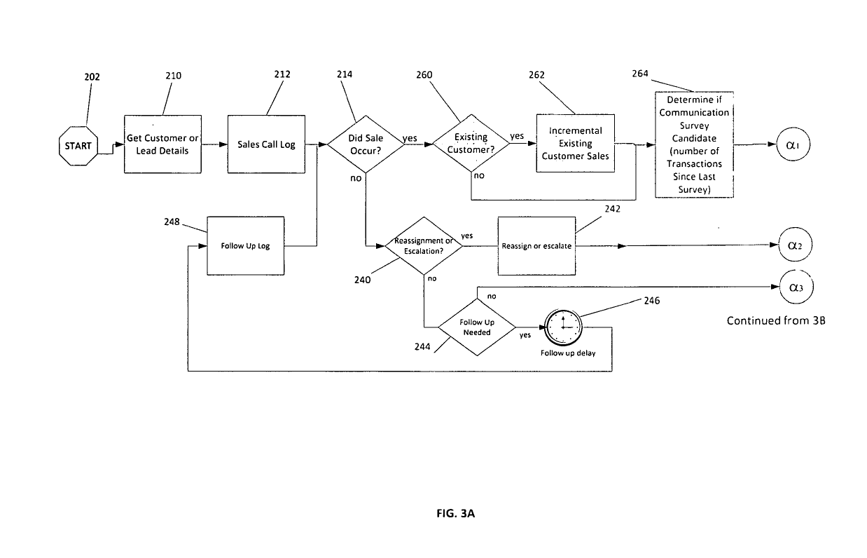

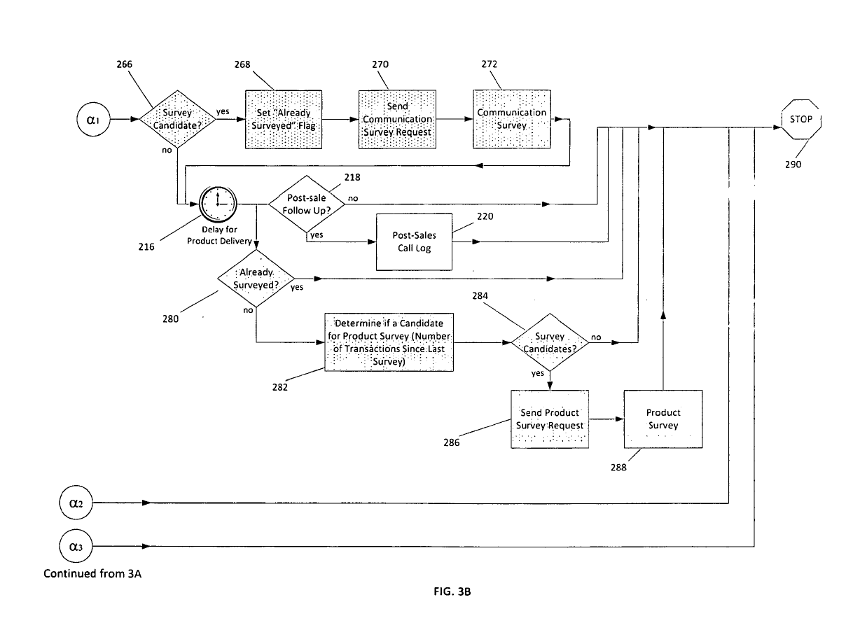

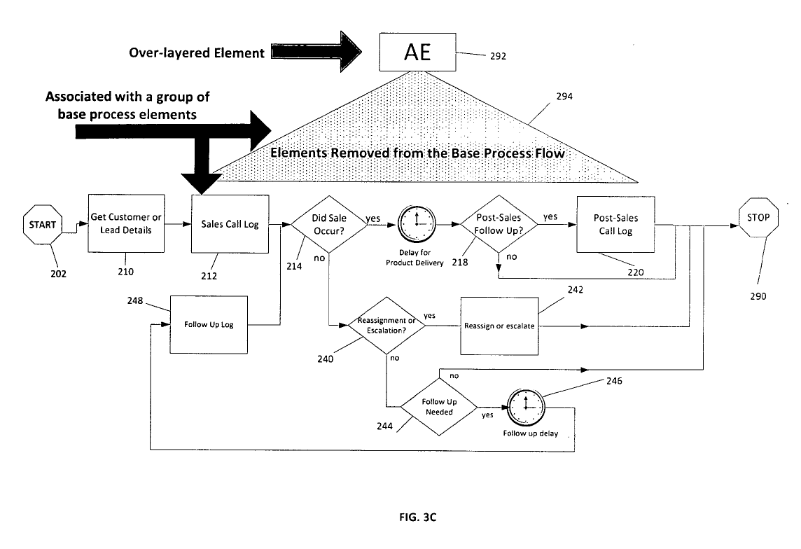

Referring to FIGS. 3A, 3B and 3C, two versions of a simplified business process flow are provided to illustrate the benefits of the present invention. Referring first to FIG. 3C, an exemplary business sales process is provided in which key performance indicators (KPIs) are to be collected within a business management process. According to the simplified process, without KPI collection, the process starts at step 202 and progresses to process element 210 where customer or local details are obtained. A call log entry is then made at process element 212 to record details regarding the customer contact. The occurrence of a sale is determined at process element 214, and if a sale did occur, then a delay function is executed at process element 216 until the product has been delivered. After product delivery, a post sales follow-up decision process element 218 is executed, and if follow-up is desired, than details of the post sales follow-up are recorded upon execution of process element 220, after which the process comes to a stop at process element 290. Going back to decision process step 214, if a sale did not occur, then a decision is made to reassign the task (e.g., to other persons) or escalate it to another process or decision level at decision process element 240, and if positive, the reassignment or escalation occurs at process element 242. The process then comes to a stop at process element 290. If the decision at decision process element 240 is negative then a determination is made at decision process element 244 as to whether a follow-up is needed. If follow-up is needed, then follow-up delay process element 246 is executed, data entries are made in the follow-up log at process element 248 and a reevaluation of the occurrence of a sale is re-executed at decision process element 214. If no follow-up is needed at process element 244 then the process comes to a stop at process element 290.

Referring now to FIGS. 3A and 3B, an expanded business process is provide in which the simple managerial process of surveying the potential customer is inserted directly into the above-described operational business process. Shaded process elements 260-288 denote these added processes. Instead of delay process element 216 directly following decision process element 214, “did the sale occur”—the same as in FIG. 3C, FIG. 3A provides for process element 260 which inquires as to whether the customer is an existing customer. If so, the business process advances to an customer sales increment process element 262 and then to a determination function at process element 264 in which communication survey candidacy is determined based on a certain number of transactions since the last survey requested by the business process. The determination function process element 264 is also reached directly if the existing customer decision process element 260 returned a “no.”

Continuing at FIG. 3B, the managerial survey process continues with decision process element 266 at which it's decided whether or not the sale is a survey candidate. If so, a “set already surveyed flag” is executed at process element 268, a “send communication survey request” function is performed at process element 270 and the “communication survey” function is executed at process element 272. Process flow then proceeds to the delay function at process element 216 as per the previously described process.

Another portion of the managerial survey process is also introduced in FIG. 3B at a parallel processing path following the delay function at process element 216. In parallel with the post-sales follow-up at decision process element 218, survey decision step “already surveyed” is executed at process element 280. If the result is yes, processing stops at 290. If no, then a determination function is executed at process element 282 in which communication survey candidacy is determined based on a certain number of transactions since the last survey requested by the business process. This is followed by the execution of decision process element “survey candidate” at process element 284. If the result is no, processing stops at 290. If the result is yes, then the process function “send product survey request” is executed at process element 286, the product survey function is executed at process element 288 and processing stops at 290.

It should be appreciated that the overall complexity of the original operational sales process provided in FIG. 3C has grown significantly through the introduction of a relatively simple management (survey) process. The number of process elements has almost doubled in FIGS. 3A-3B as compared to FIG. 3C, and the perceptual confusion resulting from the added process elements can easily render a relatively simple operational sales process obscure. Corresponding to the traditional architectural approach within a BPM environment, a business would have to describe the ‘survey’ capability they need to add to the process by adding the “shaded” additional steps to the process after which IT professionals would produce programming coding to add such capability—permanently and rigidly.

Furthermore, from an IT perspective, data stores have to be created and configured within the BPM system to accommodate the additional data and metadata created by the additional process elements. This requires the additional services of a database administrator or data architect in the initial BPM process definition and modeling. Input/output (I/O) services (e.g., web services) have to be created to provide updating functions, thereby increasing the associated development times and costs. Possibly the most challenging, the IT staff that designs and models the core operational business processes must expand their role, with the assistance of business analysts, to include the design and modeling of numerous incongruous management processes for inclusion within the operational business management processes. Each of these problems grows exponentially with every added process. Among the undesirable results are a ballooning IT budget for associated design and modeling, confusion in the rendering of the resulting business processes in view of the originally intended process, and slower computational processing by the BPM system in connection with operational business processes.

Most desirably, and a key component of this invention, is the provision of these additional processes, 294 of FIG. 3C, and the overlaying of the same on top of the base business processes. According to one aspect of the present invention, this is, provided for with an overlaid architectural element 292, i.e., the BPM service extension framework 100 of FIG. 2. This element is managed in coordination with the BPM suite's process engine 32 so that the higher order process elements are located outside of the core process model rather than being directly inserted into the core process flow. These higher order process elements are part of the extension component which includes the extension processes. For each extension process defined, modeled and executed by the extension component within the service extension framework, a subset of processes elements within the core business processes are identified as being relevant. This subset of core business elements constitute a range or scope of process elements within which the extension process operates. The subset of core process elements includes a start event process element and an end event process element. The extension process is activated only if the starting event and element are reached and terminates when the ending event and element are reached, or it is otherwise determined that there is no way to return to the ending element. Once the extension process terminates, and the core process elements are out of scope, the extension process no longer responds to changes in any of the core process variables, external data, business rules, policies, or other data/metadata with which it may be associated.

It should be appreciated that although the description above with respect to FIGS. 3A-C describe added non-core processes, the extension component is more broadly understood having the capability to adding any custom capability or any process that will facilitate non-technical business users to consume and control the custom capability by interacting through a user interface dialogue to provide different set of input values or selections. Once an extension component is created by the developer, business users are able to control how the extension component will perform by providing different input values or selections to the user interface (UI) which will then direct the core process to incur dynamically added capability or behavior—even when such capability was not originally considered at all when the core-process was designed. Additionally, the same extension component does not have to be uniquely applicable to only one specific core process. The intended capability of an extension component can be generically made available by dynamically added to any running process instance of any processes (i.e., different core-processes designed for different purpose. That being the case, the important realization of the extension component is high productivity, i.e., the BPM extension component solution needs to be highly productive to be able to deliver process excellence for non-core processes.

As another example of how an extension module may perform in this fashion, one can assume that a company recently hired a few new sales persons and they participate in the sales process as illustrated in FIG. 3C. Due to the increased number of new sales members, the sales manager may be worry about whether they really have reached acceptable performance levels after initial training. To verify this, the sales manager decides that one way to validate the performance lever is to measure a sale (or not) at element 214. The follow-up path would be taken if the sales failed and if the process execution traverses the path between element 248 and 214 more than a specified number of times (e.g., 2, 3, 5 or any appropriate number), than the manager may want to be alerted. In this case, an extension component can be created to provide the generic capability of monitoring the process execution between any two elements in the process to determine if it has happened more than a given number of times. In this case, it is important to note the following.

The intended capability of the extension component may not incur an additional visible element to the process (or core-process). Instead, the extension component may simply perform monitoring and alerting functions that are accomplished with programming code. However, instead of adding such code permanently around process elements 248 and 214, the “monitoring and alerting” capability can be made “generic” and “floating” and can be dynamically added to any two elements in any processes (or core-processes that were designed for different purposes.) In this case the user dialogue UI of this extension module may contain minimally 3 input fields—such as:
Identification of process element #1
Identification of process element #2
A number to determine after how many times of repetitive execution between the process paths of the two process elements will cause an alert to happen.

Optionally included input fields on this extension component UI dialogue may include:
The start date (when such monitoring and alerting will start)
The end date (when such monitoring and alerting will end)

This will enable the manager to determine how long such monitoring and alerting will be made available between elements 248 and 214 in the process illustrated in FIG. 3C.

Therefore, the dynamically pluggable capability to be instantiated by an extension component may not always have a “representation” of adding additional process elements to the process (or core process). Alternatively the extension component represents a dynamically pluggable generic capability/functionality that can deliver the effect of as if dynamically adding the following to one or more processes (core-processes):
One or more process fragments to the process (core process)—as if there were already taken into consideration when the core process was originally designed
Non-visible or implicit capabilities such as the monitoring and alerting capability in the above example (would have to be enabled traditionally by adding underlying code and such underlying code-enabled capability or functionality can now be dynamically added to any process (core process.)

While the following description is provided with specific reference to the application of the extension function to extension processes and the management of the same, it should be understood that the concepts may be more broadly applied as extension component functionality described above.

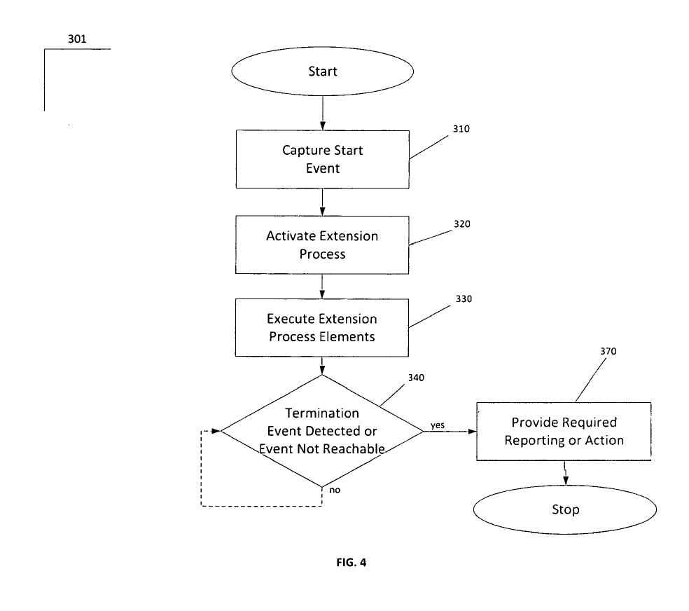

Referring now to FIG. 4, a formal high-level process flow 301 is provided for the component as coordinated between the BPM suite and the BPM service extension. As shown in FIG. 4, the start event is captured by the BPM 310 and then the extension component is activated 320. The process engine then executes the operations within the extension component to perform the functions for which the extension component was designed 330. Examples of these functions are provided in the detailed descriptions below. As shown at 340, these functions continue to be performed by the extension component through the execution of associated extension process elements or functions until either a termination event and element within the core process is detected by the component (along the yes path), or it is determined that the termination event and element cannot be reached (along the no path). In either case, any post termination extension component operations, actions and/or reporting functions may be executed by the extension component 370 prior to the full end of the process.

Any number of extension processes may be implemented with the assistance of the extension framework. A number of such highly useful processes are described below. It should be noted that the actual extension process elements for each of the examples below are not specifically show, except by way of a high level graphical representations and within the accompanying text. It should be readily apparent to those of skill in the art that these extension processes can be configured in any one of a plurality of different arrangements, on any one of a plurality of different platforms that are capable of handling the metadata generated by the base processes so as to perform the functions described below. More important than specific process elements are the interaction of the extension processes vis-à-vis the associated base processes which is the focus of these extension process descriptions.

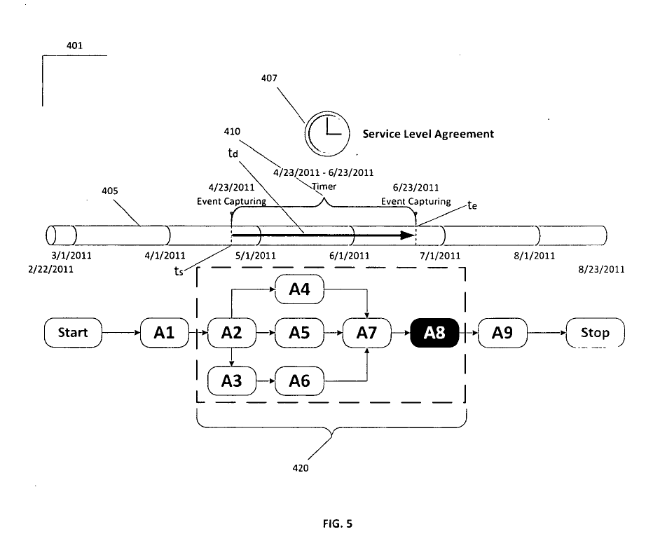

Referring to FIG. 5, an extension process 401 for implementing a service level agreement is provided. The object of the service level agreement is to ensure that the base process traverses several steps or a block of steps 420 within a designated timeframe 410, otherwise an alert is sent to the process owner or another process is triggered to handle the lagging process. Timeline 405 is monitored by the extension process. The service level agreement extension process is activated when it captures the execution of starting event and element A2 within the base process at time tₛ. A service level timer 407 is started by the extension process to begin monitoring time passage as the base process executes process elements A2-A8. Once termination event and element A8 is reached at time tₑ, the extension process captures this event and stops the service level timer. The service level extension process may then report the execution time to other extension or base processes, in real-time or as part of other reports, in combination with any other the post termination functions, i.e., 370 of FIG. 4. If during the base process execution, however, base process A8 is not reached within a preset maximum process duration t_{d}, the extension process may begin to execute exception handling procedures whereby alerts or notices are provided to BPM system users (process owners). Alternatively, or in addition to the human-perceptible alerts and notices, the service level agreement extension process may invoke other extension or base processes to handle the overdue base process. The preset maximum base process duration may be coded as part of the extension process programming or it may be provided in the form of real-time metadata generated within the BPM system.

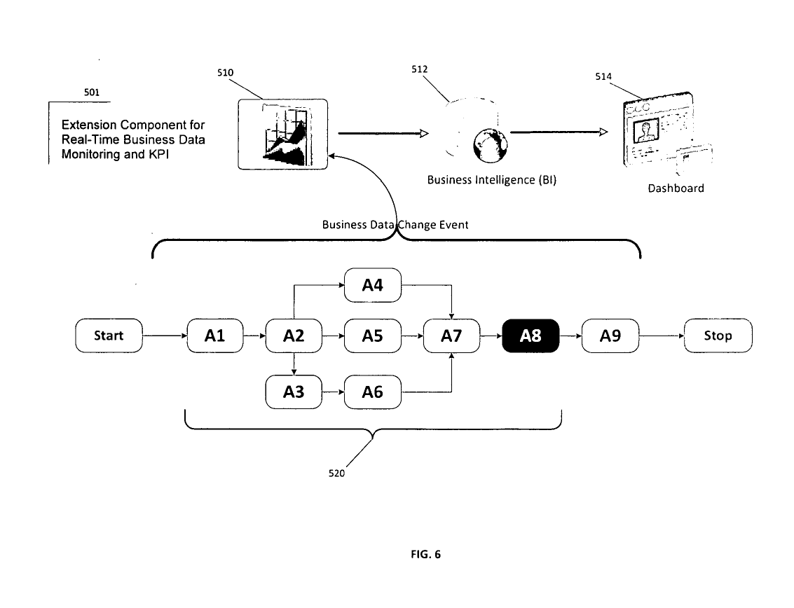

Referring to FIG. 6, a real-time business monitoring function is provided as coded in an extension process employing the collection of operational business intelligence (BI) through key performance indicators (KPIs). Operational BI KPIs are most easily collected through an automated business process that is managed by a BPM system. Performing this collection using traditional base process elements, however, is arduous, difficult to modify, and tends to make the process model very large and complex. Extension components are ideal for collecting operational BI KPIs without altering the core business process model. The configurable scope of the extension component is also perfectly suited for operational BI since it is imperative that KPIs provide insight into the performance of discreet job functions or work units. For example, if a KPI is tracking performance of the sales department, it is imperative that post-sales complications that result in no sale being made, for example, due to problems in the shipping department, are not reflected in the pure sales-related KPI. Separate KPIs, associated with another discreet range of process elements would ideally be configured to identify and directly link performance issues related to the shipping department.

Again referring again to FIG. 6, an extension process 501 is provided for implementing a business data monitoring function and the collection of associated operational BI KPIs. As described above, the objects of the business data monitoring are numerous but include monitoring the life cycle of designated key business data and measuring the performance of business process as KPI. Further, BI is made available in real time and in quick response to market changes through data integration with the BI component in the BPM system. Monitoring begins with the extension process polling and tracking the operation if a block of steps 520 (subset) within a core process. Each of the elements in this block of processes are monitored by the extension process, as programmed, for monitoring a specific business function and its performance, e.g., the sales function described above. Triggering event and element A2, e.g., the sale of a unit, may be captured by the extension process after which the extension process is activated. As the subset of core process 520 executes process elements A2-A8, the extension process 510 continues to monitor and collect business data and KPI. This data may subsequently be shared with a business intelligence (BI) component 512 for presentation to a BPM system user on a dashboard 514. This business process monitoring continues according to the high level process of FIG. 4 until a termination event and element A8 is reached, e.g., the receipt of customer payment. The extension process captures this event and terminates the business monitoring (extension) process for that particular unit sold. That is to say, the unit was fully “sold” according to the business unit's preprogrammed business rules. At this point other business monitoring processes may begin or otherwise continue to operate in connection with that particular sold unit to verify process integrity at other points in sales cycle. The business monitoring extension process may report certain data to other extension or base processes, in real-time or as part of other reports, or in combination with any other the post termination functions, i.e., 370 of FIG. 4. At any point in the business process monitoring, the extension process may begin to execute exception handling procedures whereby alerts or notices are provided to BPM system users (process owners), for example if an inordinate number of initial sales are reversed for some reason. Alternatively, or in addition to the human-perceptible alerts and notices, the business monitoring extension process may invoke other extension or base processes to handle exception processing. The threshold for exception processing may be a preset maximum value or quantity (e.g., a fixed number of reversed sales) coded as part of the extension process programming or it may be determined in the form of real-time metadata generated within the BPM system.

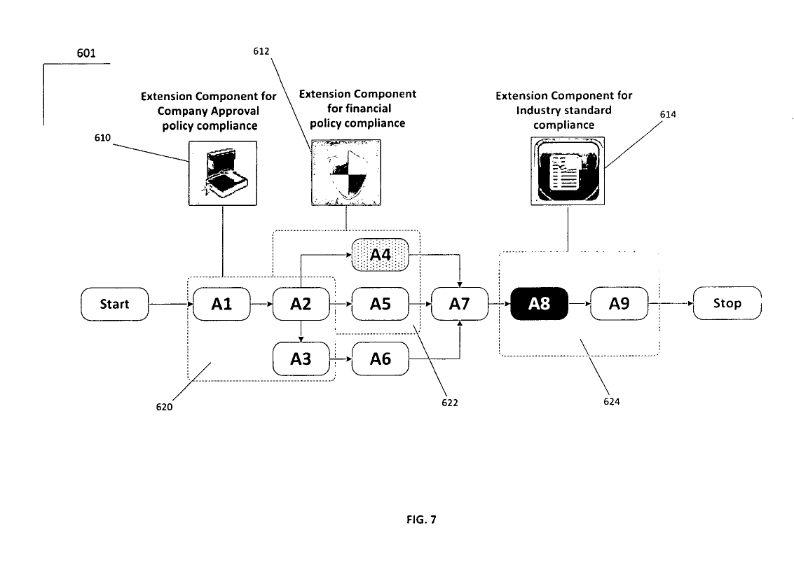

FIG. 7 shows yet another example of an extension process that may operate on the BPM extension component according to the present invention. In this policy compliance example, a business process must be verified to be compliant with a company's business policy, or alternatively a regulation. As shown above with reference to FIGS. 3A-3C, the core process model is made significantly more complex if a developer is required to create and insert compliance-related process elements, which in turn, ties up the process model and makes process changes more difficult. The extension component of the present invention is capable of decoupling the policy monitoring function and the process model. This effectively separates the BPM system roles of policy owner and process designer thereby giving policy owners more freedom to change policy implementations without being concerned about any impacts on the process model. This leads to a cost-effective and more manageable business process.

In FIG. 7, a policy compliance extension process 601 is provided for monitoring various compliance aspects of a business process. Several core sub-processes may be implicated in any given monitoring and compliance verification function. For example a subset of core process elements may be responsible for identifying the very need for policy compliance 620, and other subsets of core process elements may require general policy compliance monitoring and verification, e.g., for financial policy compliance, subset 622, or for industry compliance, subset 624. As with other extension processes operating according to the flow of FIG. 4, the compliance function, whether it be need identification or compliance monitoring/verification, is triggered by an event and element (A2, A8) as captured by the extension process after which the policy compliance extension process is activated. While the subsets of core processes elements are executed, the extension processes within extension components 610, 612, and 614 continue to monitor the operation of the process element subsets. This policy compliance monitoring continues according to the high level process of FIG. 4 until a termination event and element is reached or it is determined that policy compliance extension processes are not needed or cannot be verified. The extension process captures this event and stops the policy compliance extension process for that policy compliance function. The policy compliance extension process may report certain data to other extension or base processes, in real-time or as part of other reports, in combination with any other the post termination functions, i.e., 370 of FIG. 4. At any point in the policy compliance monitoring, the extension process may begin to execute exception handling procedures whereby alerts or notices are provided to BPM system users (policy owners), for example if policies are determined to be violated. Alternatively, or in addition to the human-perceptible alerts and notices, the policy compliance extension process may invoke other extension or base processes to handle exception processing. The threshold for exception processing may be a preset maximum threshold coded as part of the extension process programming or it may be determined in the form of real-time metadata generated within the BPM system.

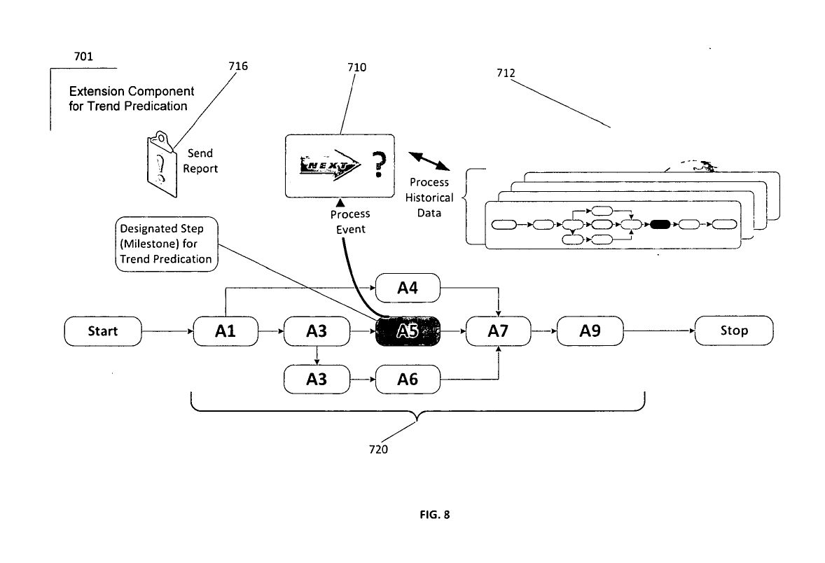

As a final example of an extension process that may operate on the BPM extension component according to the present invention, a trend prediction process is shown in FIG. 8. When the BPM system accumulates a certain amount of historical process data, the extension component is capable of providing valuable trend predication regarding a process at designated process steps based on the state of the process and statistical historical data of that same process model. Through the evaluation of process milestones, the trend prediction processes are able to help businesses determine swings in process momentum and adjusting resources accordingly.

Referring again to FIG. 8, a trend prediction extension process 701 is provided for monitoring historical operations of a business process and providing trend recognition functions in response thereto. Trend prediction begins with the extension process polling and tracking the operation if a block of steps 720 (subset) within a core process. Each of the elements in this block of processes is monitored by the extension process, as programmed, for monitoring a historical trend regarding the performance of the process. Prior to the monitoring function, extension component 710 is assumed to have collected and evaluated process historical data 712. During core subset process execution, designated milestone event and element A5 may be captured by the extension process after which the trend prediction extension process is activated. As the subset of core process elements 720 are executed while the trend prediction extension process 710 continues to monitor execution of milestone process element A5. This milestone monitoring continues according to the high level process of FIG. 4 until a termination event/element is reached. It should be realized that for historical analysis purposes and associated trend prediction, the trend prediction extension process may continue unabated for some time. Thus a breakpoint event, such as significant deviation from historical process trends at milestone element A5, may effectively terminate the extension process for the purpose of reporting or providing an alert related to the function of the milestone in relation to historical trends. In either case, the extension process captures this event and may or may not suspend the extension process from trend prediction functioning for the immediate future. At this point other business processes may commence or alternatively continue to operation in connection with the trend prediction extension process and these processes may report certain trend data to other extension or base processes, in real-time or as part of other reports 716, in combination with any other the post termination functions, i.e., 370 of FIG. 4. At any point in the trend prediction process, the extension process may begin to execute exception handling procedures whereby alerts or notices are provided to BPM system users regarding the trend metadata. Alternatively, or in addition to the human-perceptible alerts and notices, the business monitoring extension process may invoke other extension or base processes to handle exception processing. The threshold for exception processing may be a preset maximum trend deviation value coded as a permanent part of the extension process programming or it may be determined in the form of real-time metadata generated within the BPM system.

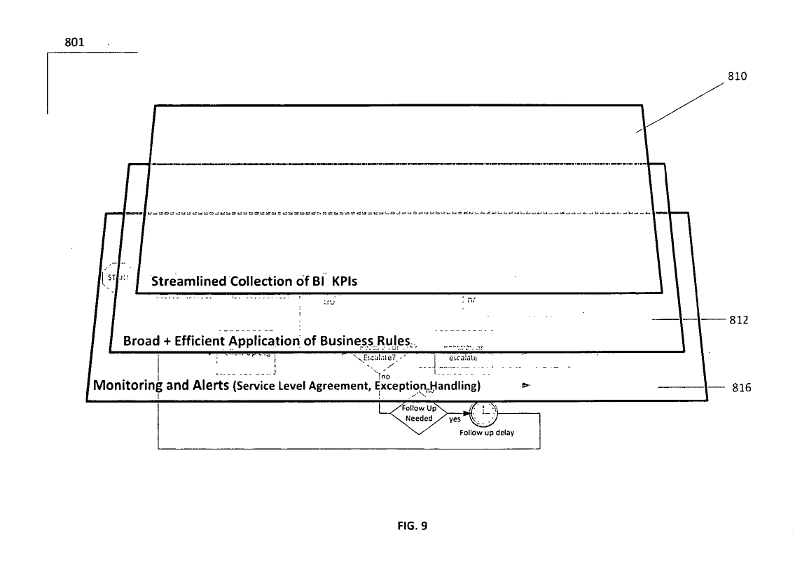

In a more sophisticated arrangement, the extension components of the present invention are capable of executing processes having advanced uses and extremely nuanced operations. This is particularly so when multiple extension components and their associated processes are nested or used in parallel and provided in FIG. 9. As shown there, multiple extension components can run on the extension framework, all in parallel, so as to perform their individual functions without corrupting the core processes. Separate extension components may be separated into layers 810, 812, 816 that can be separately maintained, often by different individuals having discreet job functions. In the exemplary graphic of FIG. 9, three extension components are shown operating in parallel on an underlying business process: a business monitoring function 810, a business rules evaluation function 812 and monitoring and alert functions 816. With just a small number of extension components, processes are allowed to be tailored within the extension component in ways that would otherwise require hundreds or thousands of process elements using traditional in-process elements. As one example, operational BI KPI thresholds can be driven by conditions from a BRE, and upon passing an acceptable threshold (as displayed in transitioning from “amber” to “red” in a BI I/O dashboard), the extension components could trigger special response and escalation plans. Modeling this level of functionality in a traditional business process model is phenomenally complex, but it made capable with a small number of nested extension components operating in the manner of the present invention.

Other business process functions are also capable of realization through the use of extension components. One highly useful example is the application of extension components for mass customization with cloud-based computing environments. This would conceivably be needed when a BPM-enabled application requires multi-tenant support. Since every customer may want to customize their own process model, process model customization would require an enormous and potentially duplicative effort. Each of those process models may be similar at high level, but each would conceivably be different in their low-level detail with the ever present possibility of dynamic alteration. The extension framework described herein provides a very unique and powerful solution for mass customization of a process model. For example, the extension components can be applied to a process model so as to configure it at design time or connect to it at run time via an extension user interface or API without changing process model. This provides a process model that is more adaptive and dynamic than traditional methods of customization.

Business Rules and Complex Event Processing: If a specific business condition is to be evaluated across a range of process elements, then a tremendous amount of work is required to either configure each element within the process range of interest or add interstitial process elements to perform the evaluation. An extension component associated with a subset consisting of the entire range of process elements provides a central place to define the evaluation condition and, optionally, the actions to be taken based on it. The condition may be defined directly in the extension component, or be provided by a BRE. If any action is required, a separate process, sub-process, or dynamic process modification can be executed. These kinds of dynamic, process-state-triggered actions are typically grouped under the heading of Complex Event Processing (CEP).

Monitoring, Alerts, and Unified Communications functions: When business processes go wrong, there is often a shared response and escalation plan for a division, department, or work team. An extension component allows that plan to be defined in one place and shared across a range of process elements. Adding monitoring, alerting mechanisms, escalation process flows, and unified communications features directly into the process model adds a huge number of process elements and makes the process model extraordinarily complex. While very important, these “rainy day” process additions are rarely executed. Adding these capabilities and features through extension components keeps the core process model simple, and makes it easier to modify the response and escalation plan(s).

While the invention has been shown and described with reference to specific preferred embodiments, it should be understood by those skilled in the art that various changes in form and detail may be made therein without departing from the spirit and scope of the invention as defined by the following claims.

What is claimed is:

1. A computer-based process management system, said process management system having a process engine that manages a process flow within a process model, said process flow containing a plurality of process elements, said process management system comprising:
an extension component disposed outside of and coupled to said process model for interacting with a subset of said process elements within said process flow, said extension component managed by said process engine and configured to perform a particular extension function.

2. The computer-based process management system of claim 1 wherein said particular extension function includes implementing a service level agreement, said service level agreement ensuring that said subset of process elements is traversed within a specified time period.

3. The computer-based process management system of claim 1 wherein said particular extension function includes performance monitoring of said subset of process elements by collecting key performance indicators.

4. The computer-based process management system of claim 1 wherein said particular extension function includes verification of policy compliance of said subset of process elements.

5. The computer-based process management system of claim 1 wherein said particular extension function includes evaluation of business conditions within said subset of process elements and taking actions based on said evaluation.

6. The computer-based process management system of claim 5 wherein said business conditions are evaluated directly by said extension component and said actions include dynamic process modification of said subset of process elements.

7. The computer-based process management system of claim 5 wherein said business conditions are evaluated with said extension component using a rules engine that is part of said process model and said actions include dynamic process modification of said subset of process elements.

8. The computer-based process management system of claim 1 wherein said particular extension function includes predication of process trends within said subset of process elements based on statistical historical data regarding said process model.

9. The computer-based process management system of claim 1 wherein said particular extension function includes alert monitoring within said subset of process elements.

10. The computer-based process management system of claim 1 wherein said particular extension function includes evaluation of business conditions within said subset of process elements and taking actions based on said evaluation.

11. The computer-based process management system of claim 1 wherein said computer-based process management system includes a plurality of said extension components to perform a plurality of particular extension functions.

12. The computer-based process management system of claim 1 wherein said computer-based process management system is a business process management system, said process model is a business process model, said process engine is a business process engine, said process flow is a business process flow within said business process model, said plurality of process elements are a plurality of business process elements and said particular extension function performed by said extension component is a particular business extension function.

13. A computer-based extension component for use with a process management system, said process management system modeling a process and having a process engine that manages a process flow within said process model, said process flow containing a plurality of process elements, said extension component comprising:
an extension foundation for coupling to and communicating with said process management system;
an extension framework having a design-time component and a run-time component, said design time component including an environment system including a user interface, said run-time component including an process engine for executing the extension component processes, said extension processes operating in connection with said process engine but decoupled from said process elements a subset of said process elements and configured by a user to perform a particular extension function.

14. A method for operating a computer-based process management system, said process management system having a process engine that manages a process flow within a process model, said process flow containing a plurality of process elements, a subset of said process elements including a starting event and an ending event, the method comprising:
capturing said starting event associated with a subset of said process element within said process flow;
activating an extension component containing extension model process elements upon capturing said starting event, said extension component process elements being separate from and operating in parallel with said subset of process elements within said process flow;
executing said extension component process elements until either said ending event is reached within said process flow or it is determined by said extension component that said ending event is not able to be reached; and
terminating execution of said extension component process elements.

15. The method of claim 14 wherein said step of activating includes activating said extension model process elements for executing a service level agreement, said extension model process elements comprising said service level agreement, said step of executing further comprising the steps:
activating a sub-process timer associated with said subset of process elements;
monitoring said sub-process timer to determine a sub-process execution time for said subset of process elements; and
triggering an alert if said sub-process time exceeds a maximum sub-process execution time.

16. The method of claim 14 wherein said step of capturing includes detection of a change in process data and said step of activating includes activating said extension model process elements for executing a performance monitoring function, said extension model process elements comprising said performance monitoring function, said step of executing further comprising the steps of:
collecting key performance indicators associated with said subset of process elements; and
reporting said key performance indicators to said extension component for evaluating a performance of said subset of process elements.

17. The method of claim 14 wherein said step of activating includes activating said extension model process elements for executing a policy compliance function, said extension model process elements comprising said policy compliance function, said step of executing further comprising the steps:
evaluating said subset of process elements for compliance with a standard;
evaluating said subset of process elements for compliance with said standard; and
triggering an alert if said subset of process elements is not compliant with said standard.

18. The method of claim 14 wherein said step of activating includes activating said extension model process elements for executing an alerting function, said extension model Process elements comprising said alerting function, said step of executing further comprising the steps:
monitoring said subset of process elements for conditions outside of a normal process range;
triggering an alert if said subset of process elements is outside of said normal process range.

19. The method of claim 14 wherein said step of activating includes activating said extension model process elements for executing a trend predication function, said extension model process elements comprising said trend predication function, said step of executing further comprising the steps:
evaluating a historical operation associated with said subset of process elements; and
adjusting at least one of said subset of process elements as the result of said evaluation.

20. A computer readable media having executable instructions for causing a processor to perform a method for operating a computer-based process management system, said process management system having a process engine that manages a process flow within a process model, said process flow containing a plurality of process elements, a subset of said process elements including a starting event and an ending event, the method comprising:
capturing said starting event associated with a subset of said process element within said process flow;
activating an extension component containing extension model process elements upon capturing said starting event, said extension component process elements being separate from and operating in parallel with said subset of process elements within said process flow;
executing said extension component process elements until either said ending event is reached within said process flow or it is determined by said extension component that said ending event is not able to be reached; and
terminating execution of said extension component process elements.
